(19) United States
(12) Patent Application Publication
(10) Pub. No.: US 2018/0078092 A1
(43) Pub. Date: Mar. 22, 2018

(54) Energy Efficient and Time Saving Two-side Heating Fry Pan

(71) Applicant: Zhongshan Liu, Plano, TX (US)

(72) Inventor: Zhongshan Liu, Plano, TX (US)

(21) Appl. No.: 15/091,109

(22) Filed: Sep. 16, 2016

(51) Int. Cl. A47J 37/10; A47J 37/06

(52) U.S. Cl. CPC A47J 37/105; A47J 2037/0617; A47J 37/0611; A47J 37/108

(57) ABSTRACT

This disclosure describes embodiments of several structures of two-side heating fry pan that can save energy and shorten cooking time. Moreover, the invented two-side heating fry pan has pressing function that enable it to do pressing and model-pressing cook to certain type of foods. The invented two-side heating fry pan also has a feature that effectively removes the oily vapor generated during the cooking process.

### CROSS-REFERENCE TO RELATED APPLICATIONS

This application claim priority from the U.S. Provisional Patent Application No. 62/061,801, EFS ID 20373974, filed Oct. 9, 2014, the entire content of which is incorporated herein by reference.

### FIELD OF THE INVENTION

The present invention relates generally to cooking wares, and more particularly to the energy efficient and time saving two-side heating fry pan with pressing function.

### BACKGROUND OF THE INVENTION

Fry pan is one of the most common cooking wares used in all families. A traditional fry pan cooks food by heating one side of the food at a time and then the other side. This cooking method consumes more energy and takes a longer time to cook food because a big portion of the thermal energy is wasted in this “one-side heating one-side waiting” cooking mode. The scattering and smelling oily vapor generated during the cooking is also a tiresome issue because it not only leaves odor in the room and deposits oil at the furniture around but also hurts cooker's health.

### BRIEF SUMMARY OF THE INVENTION

The invented “energy efficient and time saving two-side heating fry pan” abbreviated as two-side heating fry pan has a top part and a bottom part. The top part has a top heating plate and the bottom part has a bottom heating plate. The space between the top heating plate and the bottom heating plate is adjustable. The top part and the bottom part forms an enclosed cooking chamber. Furthermore, due to the cooking space adjustable feature, the food to be cooked can be tightly sandwiched between the top heating plate and the bottom heating plate to form a good contact of both sides of the cooked food to the heating plates to increase the contact thermal conduction thus increase the heat efficiency. So this invented two-side heating fry pan can heat food on both sides effectively at same time in an enclosed chamber, thus reduce the cooking time and heat loss. The invented two-side heating fry pan also possesses pressing function that allows the cooker to do pressing and model-pressing to certain type of food.

Since the invented two-side heating fry pan has an enclosed cooking chamber, a ventilating accessory that directly attached to the two-side heating fry pan can effectively remove the scattering and smelling oily vapor generated during the cooking thus keep the cooking environment clean.

### BRIEF DESCRIPTION OF THE DRAWINGS

In order to understand the features of the invention, a detailed description of the invention may be had by reference to certain embodiments, some of which are illustrated in the accompanying drawings. It is to be noted, however, that the drawings illustrate only certain embodiments of this invention and are therefore not to be considered limiting its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout various views. Thus, for further understanding of the invention, reference can be made to the following detailed description, read in connections with the drawings in which:

FIG. 1 is general illustration of cross-sectional view (a) and top view (b) of the invented two-side heating fry pan which comprises a top part 100, a bottom part 400, a top handle 100h, a bottom handle 400h, a height adjustable hinge 200, and a pressing assembly 300. There are heating elements 001 integrated in both the top part 100 and the bottom part 400.

FIG. 2.1 shows front (a) and side (b) view of one embodiment, screw adjusting hinge, of the height adjustable hinge 200 in FIG. 1.

FIG. 2.2 shows front (a) and side (b) view of another embodiment, hook-up hinge, of the adjustable hinge 200 in FIG.1.

FIG. 2.3 shows front (a), side (b), and top (c) view of another embodiment, slide-adjusting hinge, of the adjustable hinge 200 in FIG.1.

FIG. 3.1 shows front (a) and side partial cross-sectional (b) view of one embodiment of the pressing assembly 300 in FIG.1.

FIG. 3.2 is front (a) and side partial cross-sectional (b) view of another embodiment, external clamp, of the pressing assembly 300 in FIG.1.

FIG. 3.3 is front (a) and side partial cross-sectional (b) view of another embodiment, winch, of the pressing assembly 300 in FIG.1.

FIG. 4 is the general illustration of another embodiment of the invented two-side heating fry pan, which comprises a hinge 210, a top part 110, a bottom part 410, a top handle 110h, a bottom handle 410h, a top pressing assembly 500, a top heating plate 112, a ventilating exit 118, and a locker 600.

FIG. 5.1 depicts one embodiment of the pressing assembly 500 in FIG. 4. In this embodiment, the pressing assembly is formed by a pressing screw 501a and a support rack 501b.

FIG. 5.2 is front cross-sectional (a) and top (b) view of another embodiment of the pressing assembly 500 in FIG.4. An adjusting nut 502b along a screw pole 502a in the assembly is used to adjust the space between the top heating plate 112 and the bottom wall of the bottom part 410. 502c is a support rack.

FIG. 6.1 is front (a), side A-A cross-sectional (b), and top (c) view of one embodiment, hook-up locker, of the locker 600 in FIG. 4. The hook-up locker in this embodiment comprises a hooker 601a, a hooker holder 601c, a release button 601b, and a spring 601d.

FIG. 6.2 shows a ring locker, another embodiment of the locker 600 in FIG. 4. As a lock-ring 602 moves to the lock-position (a) or un-lock-position (b), the top part and the bottom part of the fry pan will be locked or un-locked. Side A-A cross-sectional view of the ring locker 602 is shown in (c).

FIG. 6.3 shows front (a), top (b), and side cross-sectional (c) view a hook up hinge, another embodiment of the hinge 210 in FIG. 4.

FIG. 7 is general illustration of another embodiment of the two-side heating fry pan. In this embodiment, a top part 110 and a bottom part 410 of the fry pan are locked by a rim locker 603 which has a number of sections and each section comprising a groove 603a and a protruding ridge 603b.

FIG. 7.1 is the top view of the rim locker 603 at the un-locked position.

FIG. 7.2 is the front (a) and top (b) view of a slide-in hinge 210 in FIG. 7.

FIG. 8 is a schematic view of one embodiment of the two-side heating fry pan with an adjustable lever. 113 is a top heating plate stem, 114a is a lever arm, and 114b is a guiding slot.

FIG. 8.1 is a schematic drawing that illustrates the lever arm 114a in a released position (a) and a pressed position (b).

FIG. 8.2 is front (a), top (b) and side (c) view of the lever arm 114a.

FIG. 8.3 is front (a) and side cross-sectional (b) view of the guiding slot 114b.

FIG. 9 is a schematic view of another embodiment of the two-side heating fry pan with a fixed pressing lever 115.

FIG. 9.1 illustrates the side view (a) and the top view (b) of the pressing lever 115 hooked up to the top part 110 of the fry pan with a hook up hinge 116.

FIG. 10 is a schematic view of a ventilating pipe which is connected to a ventilating exit 118 on the top part of the fry pan. The filter 002 is used to remove the oil from the vapor during the cooking. A fan 003 placed in the middle part of the pipe generates sucking air flow.

FIG. 11 is a schematic view of an adjustable top heating plate attached to an ordinary fry pan.

FIG. 12 is a schematic diagram showing the divider 004, an accessory for making a multi-layer pancake.

FIG. 13 shows the shape of a piece of dough that model pressed by a two-side heating fry pan with the divider 004.

### DISCLOSURE OF THE INVENTION

The object of this invention is an energy efficient and time saving cooking ware: two-side heating fry pan. Furthermore, this two-side heating fry pan has pressing and ventilating function.

The basic features of the invented two-side heating fry pan are described as bellow:

It has two heating plates, top and bottom heating plates; the space between the top heating plate and the bottom heating plate is adjustable to accommodate the foods with different size; the top heating plate can be pressed down to apply desirable pressure for press modeling to certain type of food; it has an enclosed cooking chamber and a ventilating accessory which can directly suck out the oily vapor from the cooking chamber of the two-side heating fry pan during cooking.

There are two major types of structures of the invented two-side heating fry pan. In a first type two-side heating fry pan, the top heating plate and the top part of the two-side heating fry pan are integrated together; the distance between the top and bottom heating plates is adjusted through a height adjustable hinge. While the top heating plate in a second type two-side heating fry pan is separated from the top part of the two-side heating fry pan, the distance between the top and bottom heating plates is controlled by adjusting the position of the top heating plate.

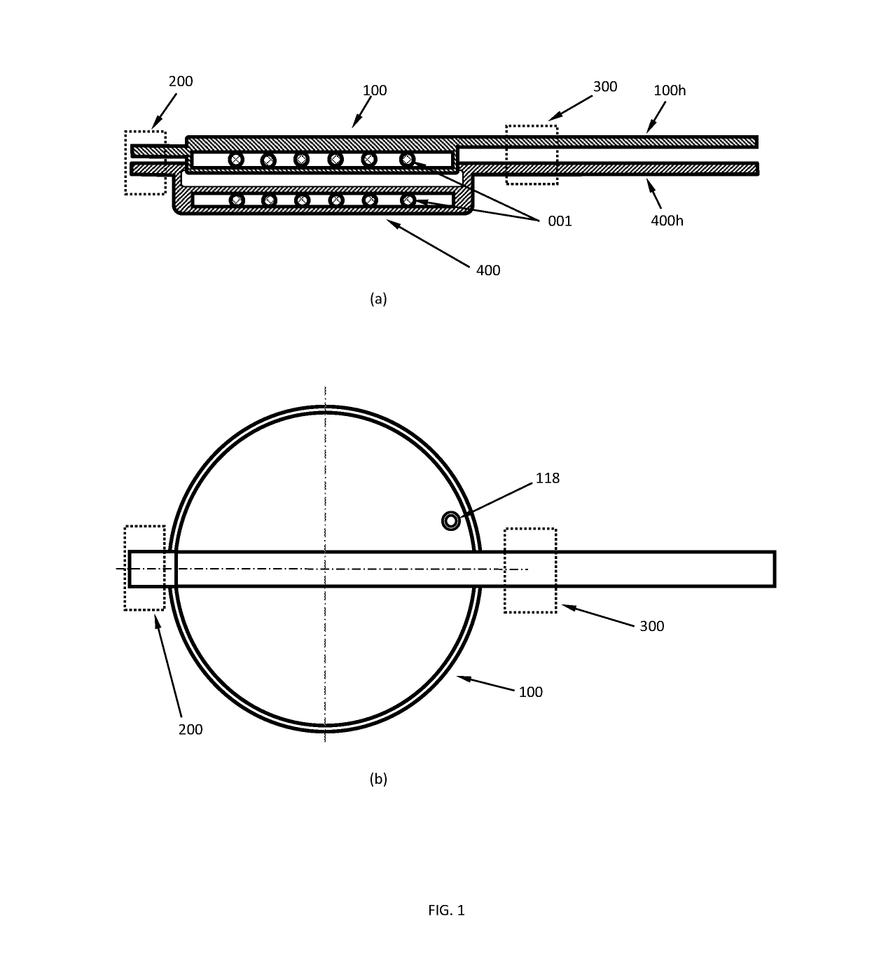

FIG. 1 shows the schematic diagram of the first type two-side heating fry pan. It comprises a top part 100, a top handle 100h, a bottom part 400, a bottom handle 400h, a height adjustable hinge 200, and a pressing assembly 300. Temperature controllable heating elements 001 are integrated into the top part 100 and the bottom part 400 to form the top heating plate and the bottom heating plate. The height adjustable hinge 200 connects the top part 100 and the bottom part 400 to form an enclosed cooking chamber and adjust the cooking distance which is the distance between the top heating plate and the bottom heating plate. The pressing assembly 300 provides the necessary pressure to the food between the top and the bottom heating plates when it is needed. This pressing capability enable the fry pan cooking certain food with press-modeling method. A ventilating exit 118 which connects to a ventilating pipe for removing the oily vapor during the cooking. The ventilating exit is located on the top part. The top part 100 further comprises a top wall and a side wall. The shape of the top wall can be circular but is not limited to a circular shape. The encircled shape of the side wall is basically following the shape of the top wall. Similarly, the bottom part 400 further comprises a bottom wall and a side wall. The shape of the bottom wall is same as the shape of the top wall of the top part. The encircled shape of the side wall is basically following the shape of the bottom wall but vertically a concave shape is preferred.

The effective height of the adjustable hinge 200 can be changed so that the cooking distance can be adjusted to accommodate the food being cooked. The hinge 200 can also be easily detached, so that the top part 100 and the bottom part 400 of the two-side heating fry pan is separated for easy cleaning.

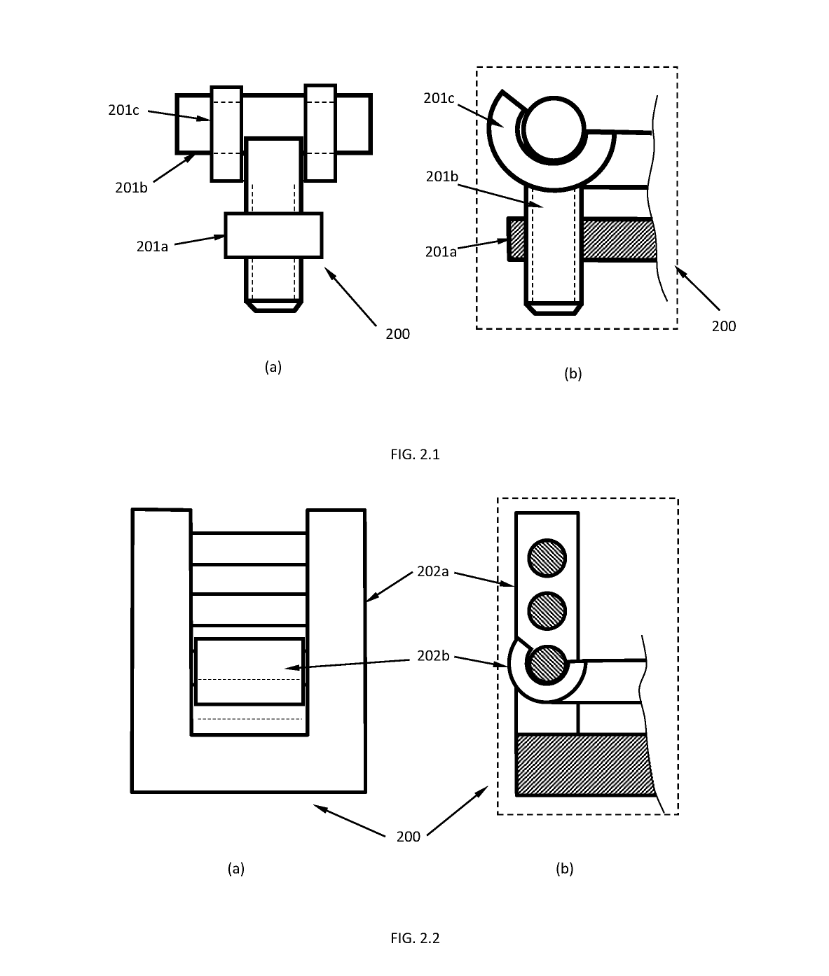

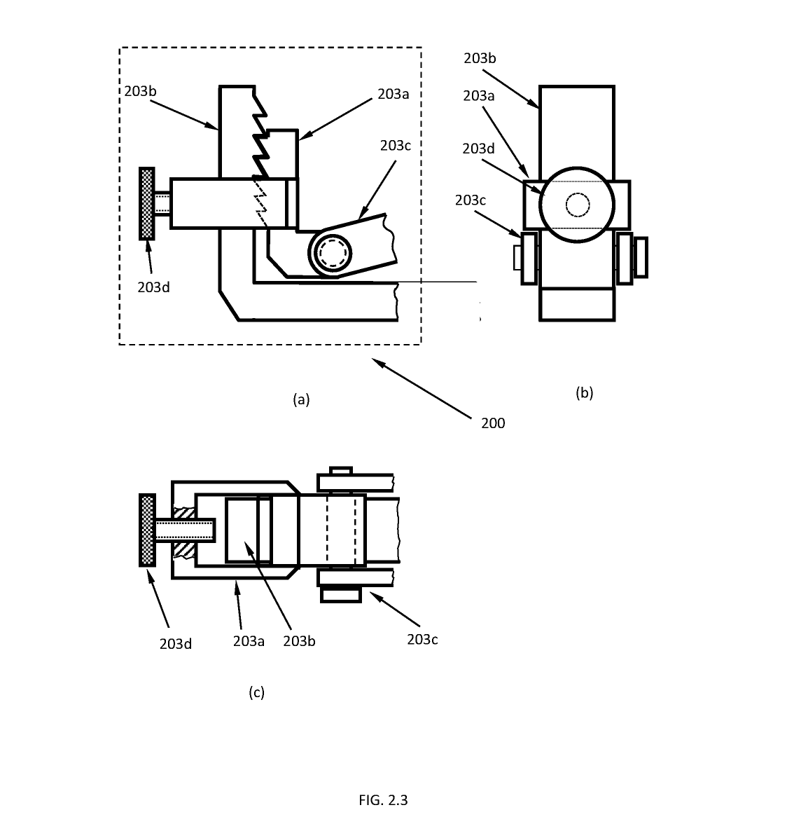

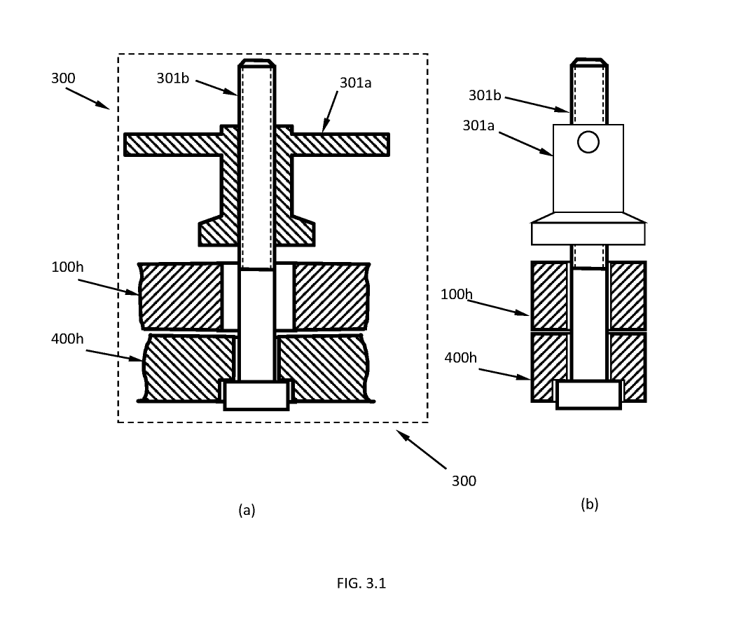

FIG. 2.1 shows one embodiment, screw-adjusting hinge, of the adjustable hinge 200 in FIG. 1. It comprises a hinge support 201a, a T-shaped screw 201b, and a hinge hook 201c. Adjustment to the cooking distance is made through screwing up or down the T-shaped screw 201b on the hinge support 201a which is connected to the bottom part 400. Once the distance adjustment is made, hook up the hinge hook 201c, which is connected to the top part 100, to the T-shaped screw 201b to connect the top part 100 to the bottom part 400.

FIG. 2.2 shows another embodiment, hook-up hinge, of the adjustable hinge 200 in FIG. 1. Adjustment to the cooking distance in this embodiment is made through choosing different bars on the hook-up frame 202a, which is connected to the bottom part 400, to hook up the hinge hook 202b which is connected to the top part 100.

FIG. 2.3 shows another embodiment, slide-adjusting hinge, of the adjustable hinge 200 in FIG. 1. Adjustment to the cooking distance in this embodiment is made by sliding up or down the movable toothed member 203a, which is connected to the top part 100 through a connection hinge 203c, to a desired position at the fixed toothed member 203b, which is connected to the bottom part 400, and then lock it up by tightening the tighten screw 203d on the side of the movable toothed member 203a.

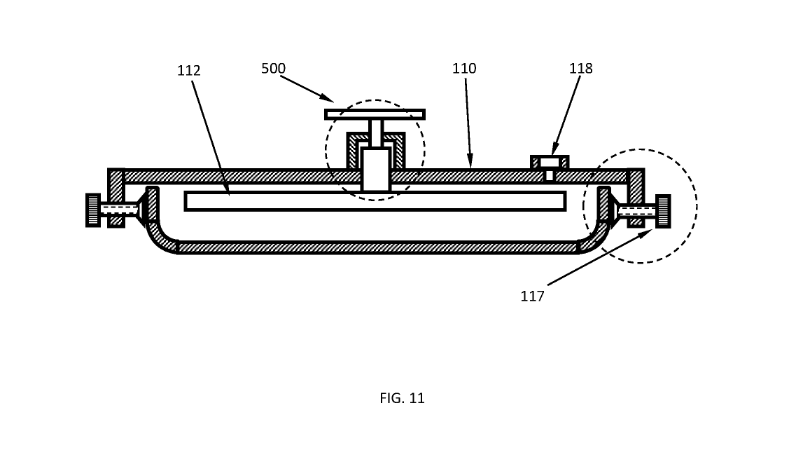

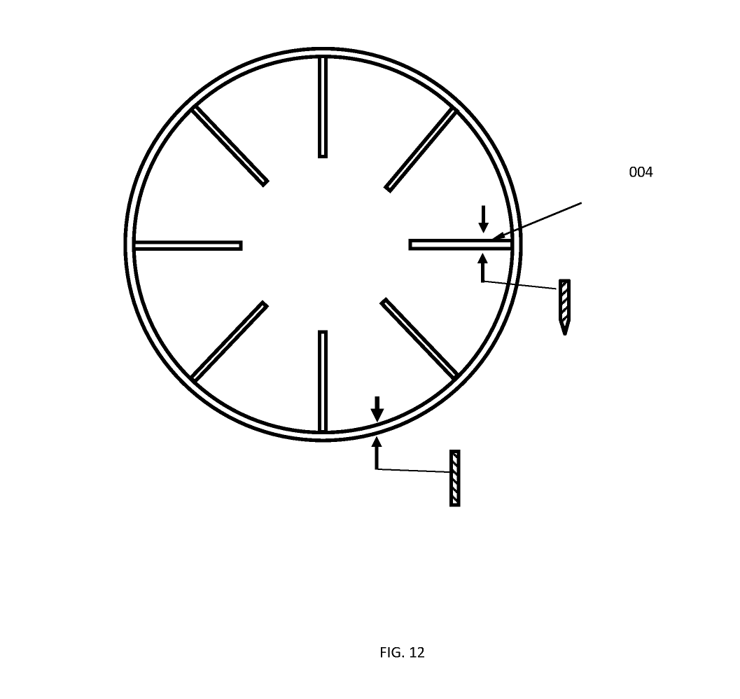

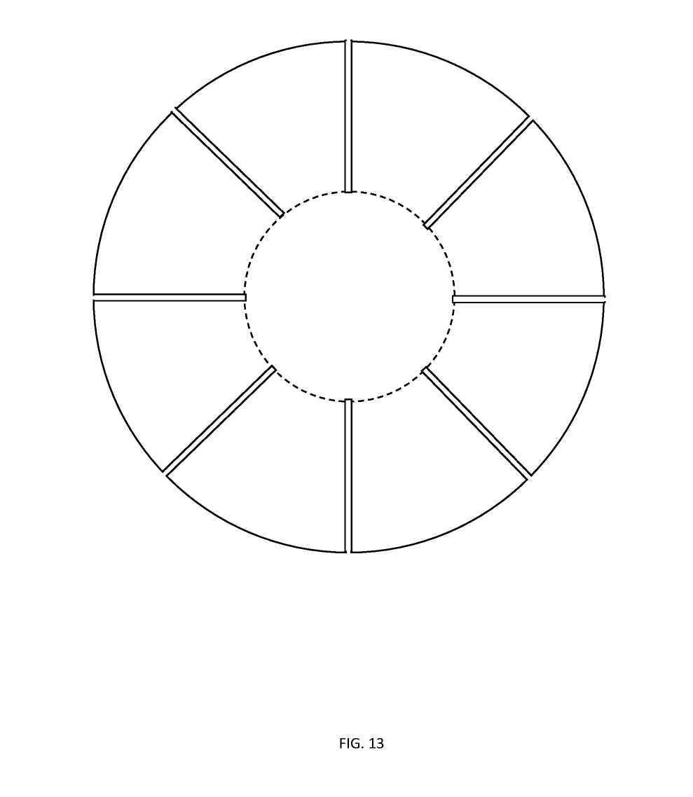

The pressing assembly 300 in FIG. 1 is designed for the food that need be pressed down for shaping (press-modeling). For example, in one Chinese cooking method, a hard to chew pancake is made first, and it is then sliced and further cooked with various kinds of meats and vegetables. Making such a hard thin pan cake from a dough might need tens of kilogram pressing down force. Another example of press-modeling is making a multilayer pancake, one of the most popular Chinese foods. To make a multilayer pancake with invented fry pan, an accessory named divider 004 (as depicted in FIG. 12) is used as pressing model. By using the divider 004, a piece of dough is first model-pressed into a circular shape with a number of radiant cuts (as shown in FIG. 13) in the two-side heating fry pan. (The shape between adjacent radiant cuts is called a pedal here) Then, after applying a thin layer of cooking oil and green onion (or any other favorited seasonings) on the surface of pressed dough and folding all the pedals along the dotted lines (as shown in FIG. 13), it is pressed again by the top heating plate to form a multi-layer pan cake. Follow up immediately with heating up both the top and the bottom heating plates, a multi-layer pancake can be cooked out right away. This pressing and cooking method can, obviously, save a lot of time for making a thin pan cake because it combines the step of making a thin sheet of cake from a piece of dough and the step of cooking the cake into a one-step task.

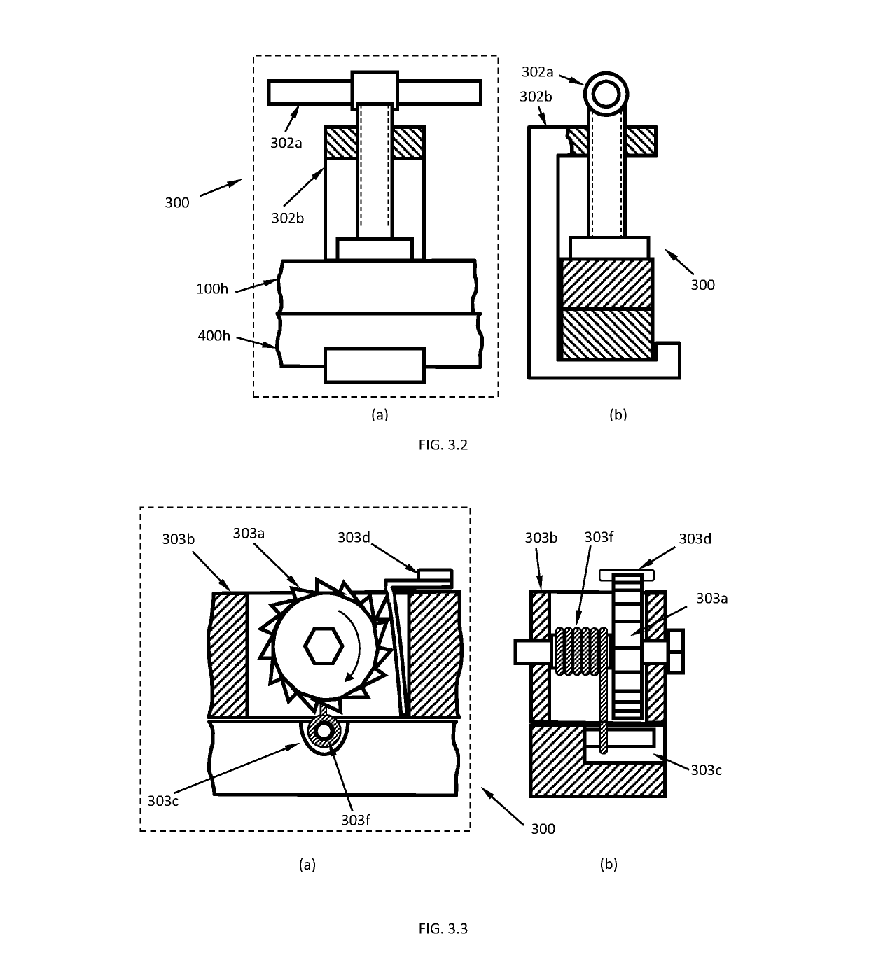

FIG. 3.1 shows one embodiment of the pressing assembly 300 in FIG. 1. The pressing assembly 300 in this embodiment comprises a cap nut 301a, a bolt 301b. The pressing force is provided by screwing down the cap nut 301a along the bolt 301b to compress the certain section of the handles of the fry pan where holes are constructed on both top handle 100h and the bottom handle 400h so that the bolt 301b can get through. The pressing force on the handles is eventually transfered to the food between the top heating plate and the bottom heating plate.

FIG. 3.2 shows another embodiment of the pressing assembly 300 in FIG. 1. In this embodiment, an external screw driven damper comprising a driving screw 302a and a clamp frame 302b is used to press the top handle 100h and the bottom handle 400h of the two-side heating fry pan, thus pressing the top part 100 and bottom part 400 of the fry pan.

FIG. 3.3 shows yet another embodiment, of the pressing assembly 300 in FIG. 1. The pressing assembly in this embodiment comprises a winch drum 303a, a winch rack 303b, a rope holder 303c, a rope 303f, and a ratchet paw 303d. The drum 303a is mounted on the winch rack 303b, which is constructed in a section of the top handle 100h of the fry pan. The winch drum 303a is used to roll up the rope 303f, which has one looped end hitched on the rope holder 303c, for pulling the top part 100 and the bottom part 400 of the fry pan close to press the food between them. The winch drum 303a has a toothed ratchet at one side. This ratchet and a ratchet paw 303d work together to allow one directional pulling of the winch only. The ratchet paw 303d can be released by pulling a button on the top of the ratchet paw away so that the ratchet paw is separated from the winch drum. One end of the rope 303f is fixed on the winch drum 303a while the other looped end is hitched on the rope holder 303c, which is built in a section of the bottom handle 110h of the fry pan. The winch drum 303a can be rolled by a fixed handle or a socket wrench.

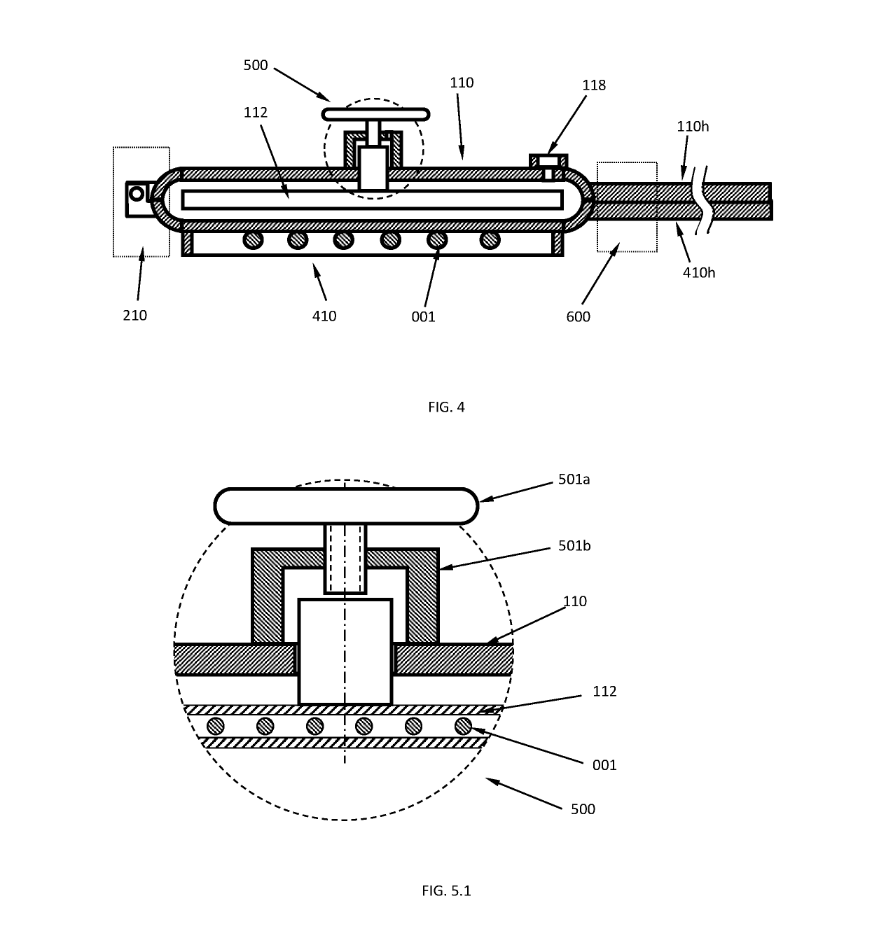

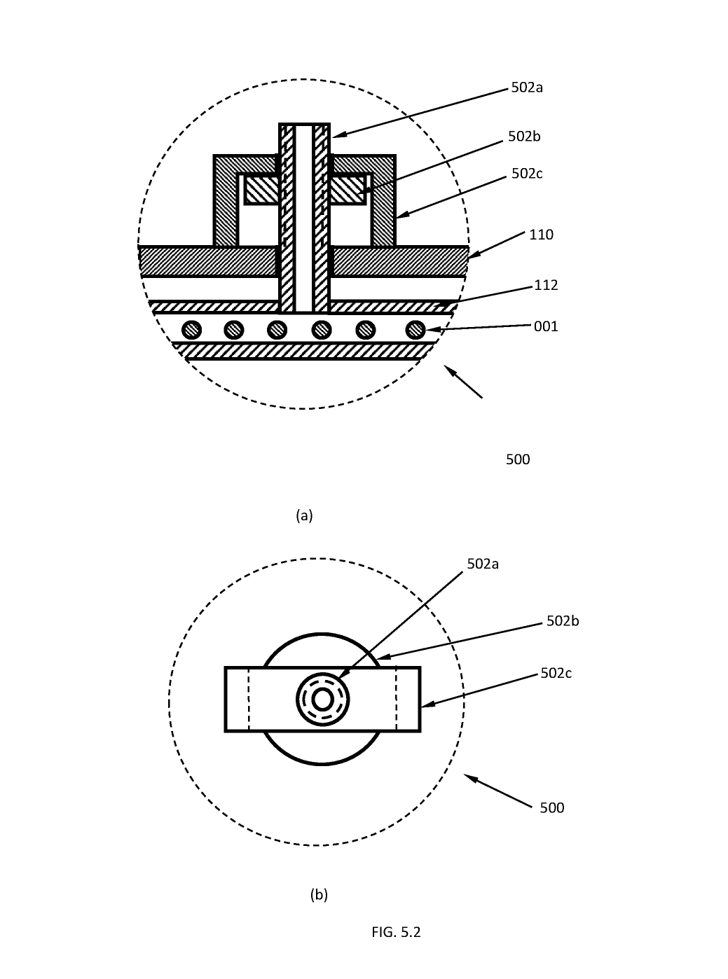

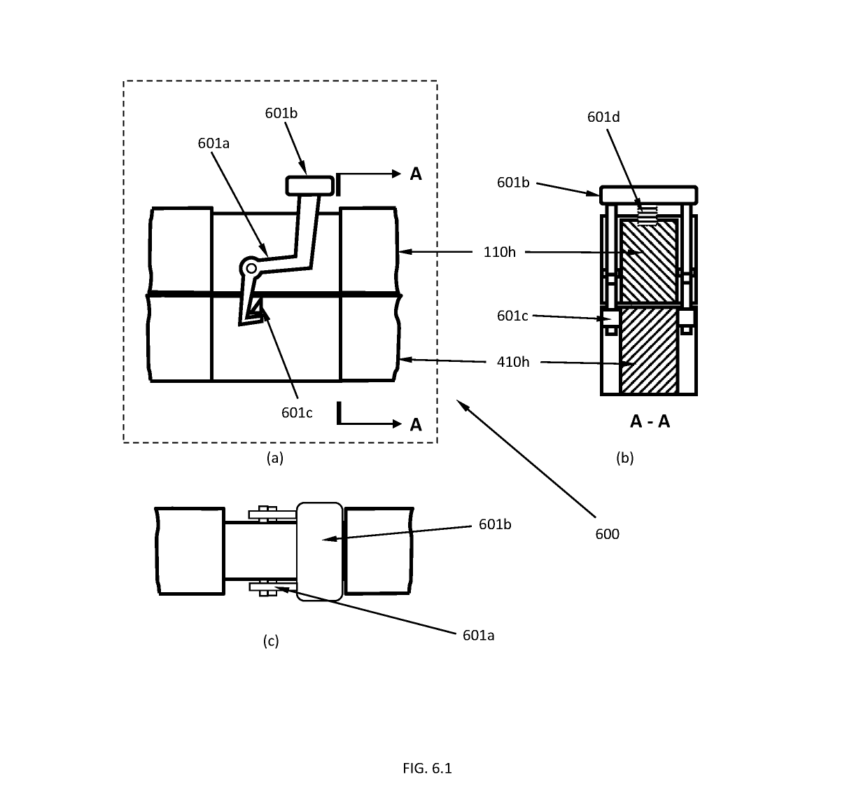

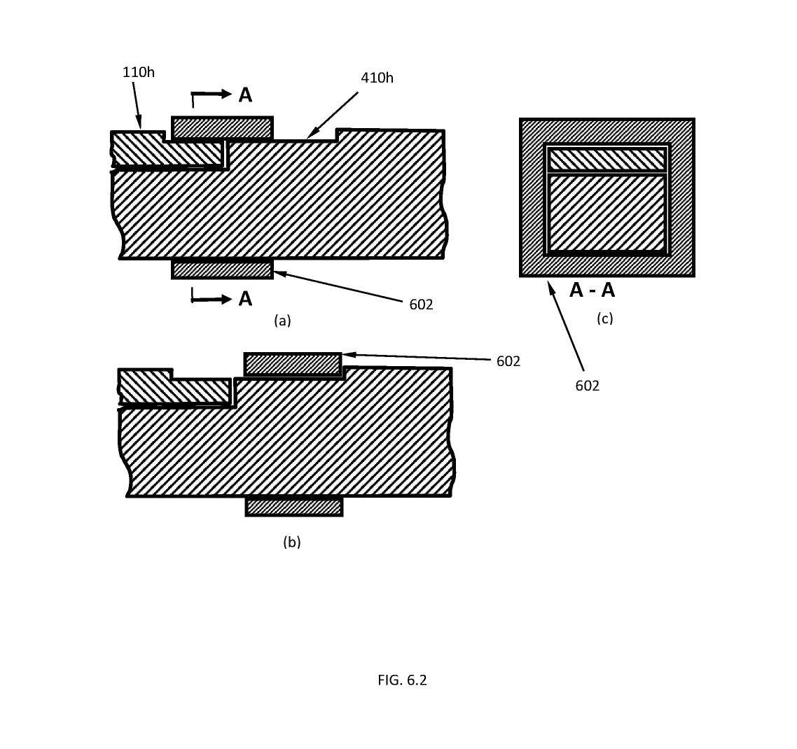

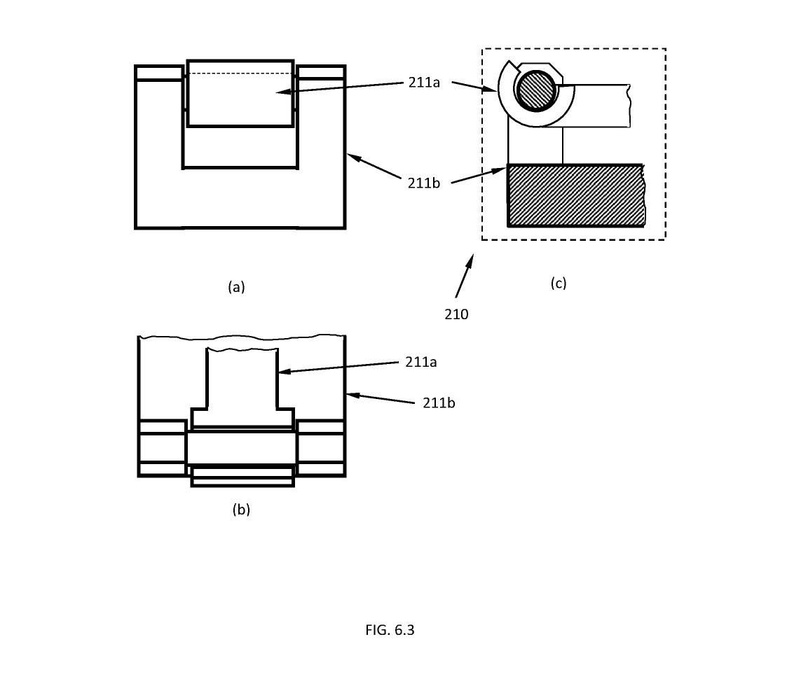

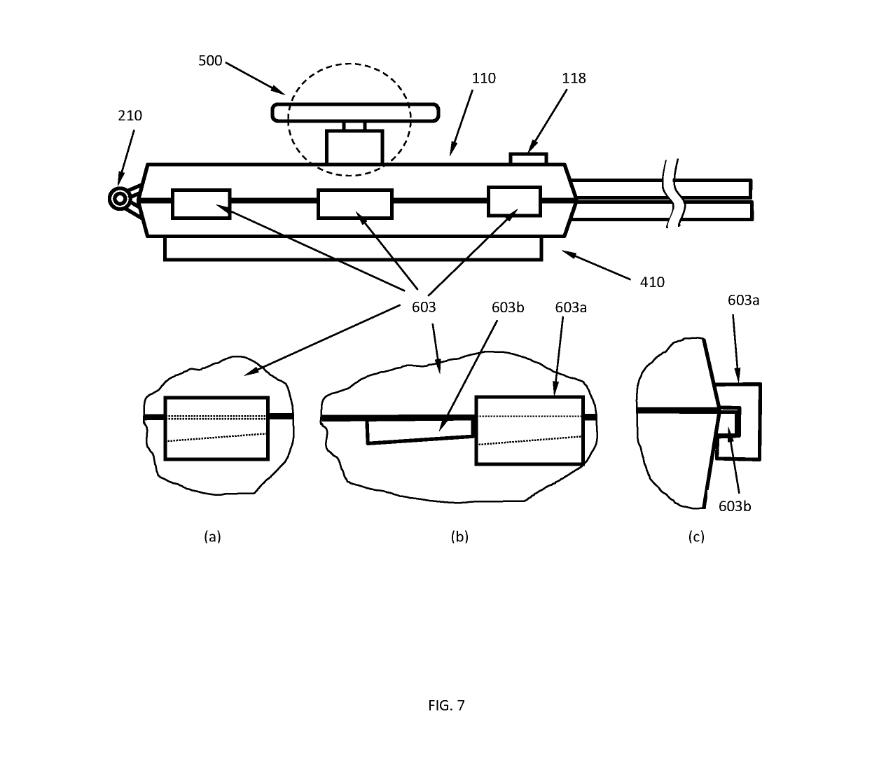

FIG.4 shows the schematic diagram of a second type two-side heating fry pan. In this exemplary embodiment, the fry pan comprises a top part 110, a top heating plate 112, a bottom part 410, a top handle 110h, a bottom handle 410h, a pressing assembly 500, a hinge 210, a ventilating exit 118, and a locker 600. Heating elements 001 is integrated in the top heating plate 112 (as shown in FIG. 5.1) and in the bottom part 410. The top heating plate 112 is not bonded to the top part 110. It can be moved along the vertical direction of the top part 110 by screwing up/down a pressing screw 501a (as shown in FIG. 5.1) or an adjusting nut 502b (as shown in FIG. 5.2). The pressing assembly 500 provides pressure to the top heating plate 112 and controls the cooking space between the top heating plate 112 and the bottom wall of the bottom part 410. The hinge 210 is the joint of the top part 110 and bottom part 410 of the two-side heating fry pan. The hinge 210 can be a fixed hinge, a hook up hinge as shown in FIG. 6.3 or a slide-in hinge as shown in FIG. 7.2. The hook up hinge or slide-in hinge allows the top part and the bottom part of the two-side heating fry pan to be pulled apart for the convenience of cleaning and storage. The fry pan is closed and locked by a locking assembly 600 to form an enclosed cooking chamber before cooking. A ventilating exit 118 is located on the top part 110 for removing the oily vapor generated in the cooking process. There are a number of pin-hole distributed on the top part 110 for inletting the air to maintain the pressure inside the cooking chamber neutral.

FIG. 5.1 shows one embodiment of the pressing assembly 500 in FIG. 4. In this embodiment, the pressing assembly 500 comprises a pressing screw 501a and a support rack 501b mounted on the top part 110 of the fry pan. The cooking space, which is the distance between the top heating plate 112 and the bottom wall of the bottom part 410, is adjusted by screwing up or down the pressing screw 501a. The pressing screw 501a is also used to provide the pressing force to the cooked food when it is needed. FIG. 5.2 shows another embodiment of the pressing assembly 500 in FIG. 4. In this embodiment, the pressing assembly 500 comprises a screw pole 502a which is connected to the top heating plate 112, an adjusting nut 502b, and a support rack 502c. The adjusting nut 502b along the screw pole 502a in the assembly is used to adjust the cooking space and provide the pressing force.

The locking assembly 600 in FIG. 4 or 603 in FIG. 7 provides means for keeping the top part 110 and the bottom part 410 of the fry pan tightly closed when the pressing assembly 500 is applying the pressure to the food been cooked. There are two basic type of structures for the locking assembly. One is side locker and another is rim locker. The side locker is presented as the locking assembly 600 in FIG.4. There could be many mechanical ways to lock the top and bottom parts together at a side location of the two-side heating fry pan. For example, FIG. 6.1 and FIG. 6.2 show two of the easy methods of locking the two-side heating fry pan at the pan handles. FIG. 6.1 shows a hook type locker. When the top handle 110h of the fry pan is pressed down, the hooker 601a, which is connected to the top handle 110h, will snap-fit to the hook-holder 601c which is connected to the bottom handle 410h of the fry pan, thus locking the fry pan. The spring 601d under the release button 601b will provide the necessary force to keep the hooker 601a in a hooked position. By pressing the release button 601b, the hooker 601a can be released, thereby opening the fry pan. FIG. 6.2 illustrates a ring type locker presented as the locking assembly 600 in FIG. 4. In this design, the top handle 110h is shorter than the bottom handle 410h. The lock-ring 602 is located near the end of the top handle 110h. To lock the fry pan, simply slide the lock-ring 602 to the lock position (as shown in FIG. 6.2 (a)). When the lock-ring 602 slides to the un-lock position (as shown in FIG. 6.2 (b)), the fry pan is unlocked and can be opened.

FIG. 7 shows schematically the rim locker 603. As shown in FIG. 7, a plurality sections of rim lockers 603 distributed along the rim of the two-side heating fry pan to lock the fry pan. Each section of the rim locker 603 is formed by a groove 603a on the top part 110 and a protruding ridge 603b on the bottom part 410 of the fry pan or vice versa. When the top part 110 of the fry pan is rotated in the direction for locking, the ridge 603b will fit in the groove 603a as shown in FIG. 7 (a) and (c), thus locking the fry pan. The contact surfaces of the grooves and the ridges are slanted, as show in FIG. 7, so that the fry pan will be tightly closed when it is rotate-locked. When the top part 110 is rotated to the un-lock position as shown in FIG. 7 (b), the top part is released; meanwhile the male part 210a of a slide-in hinge 210 will slide into the female part 210b to make the hinge functional as showed in FIG. 7.1, thereby, the top part 110 of the fry pan can be turned to open. Furthermore, the top part of the fry pan can be pulled out of the slide-in hinge so that the top part and the bottom part is separated for easy cleaning after use. The structure of the slide-in hinge 210 is illustrated in FIG. 7.2.

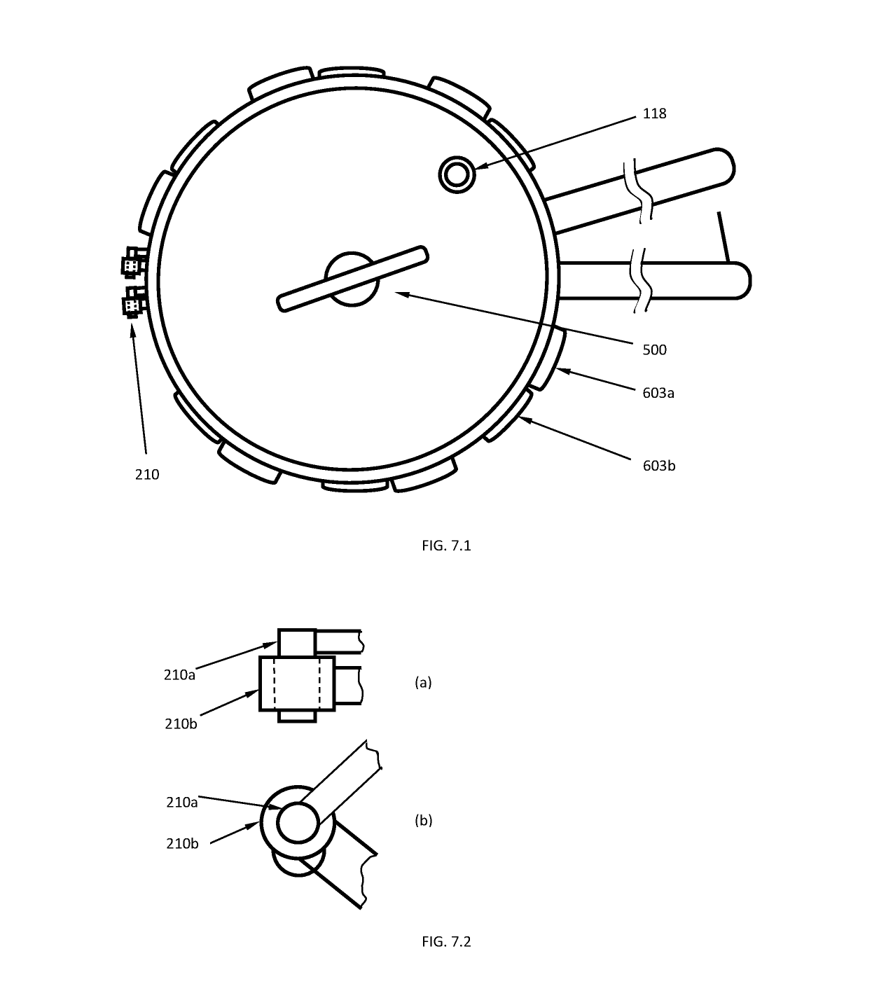

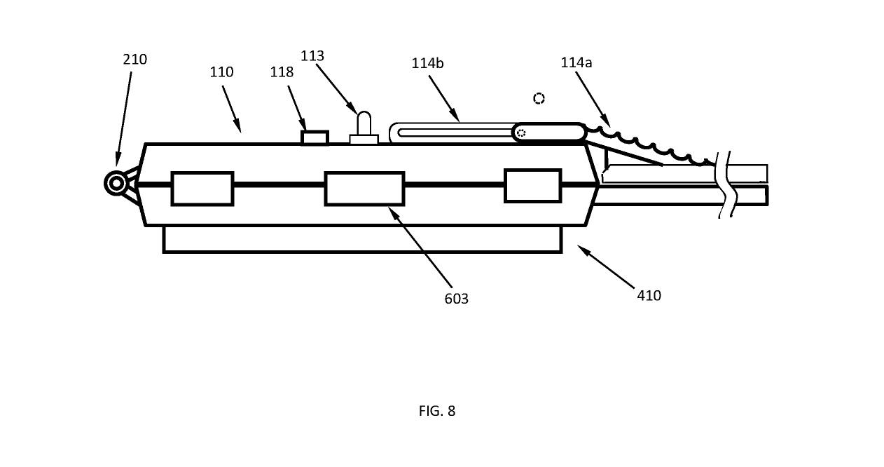

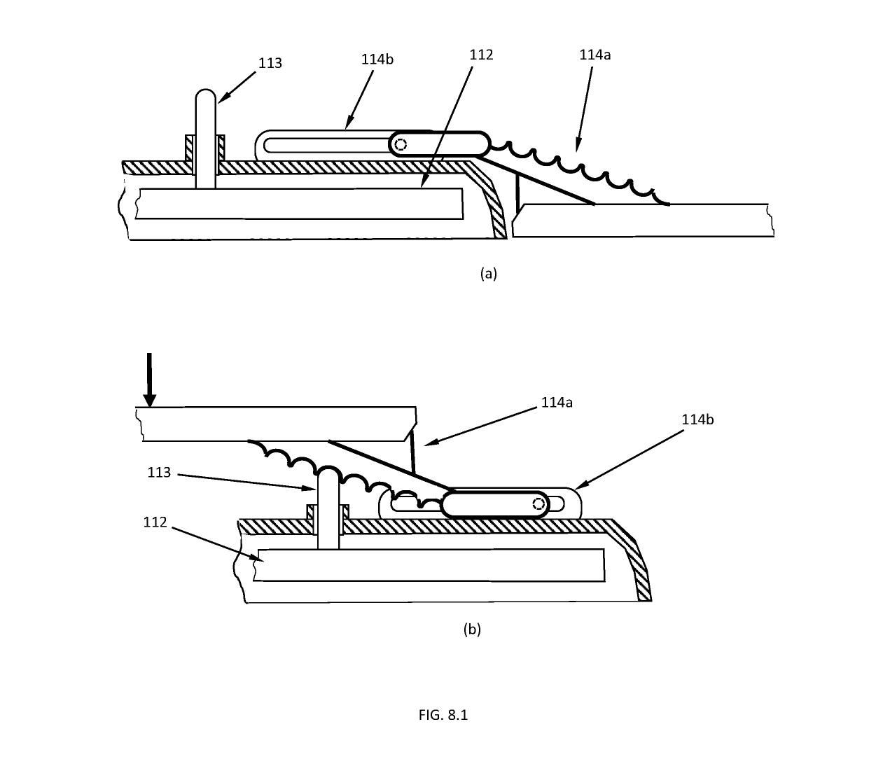

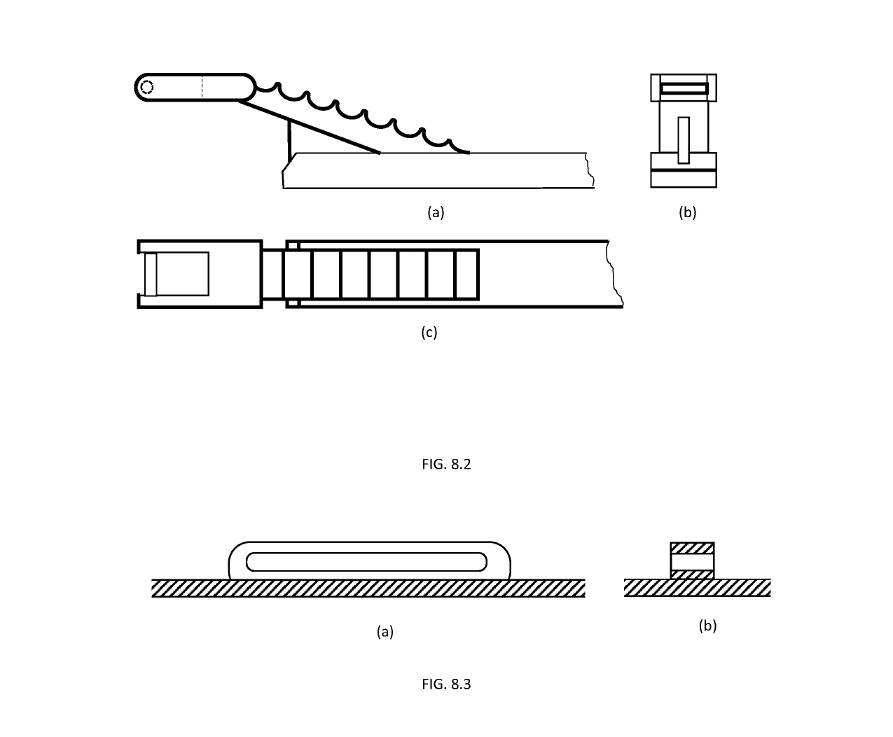

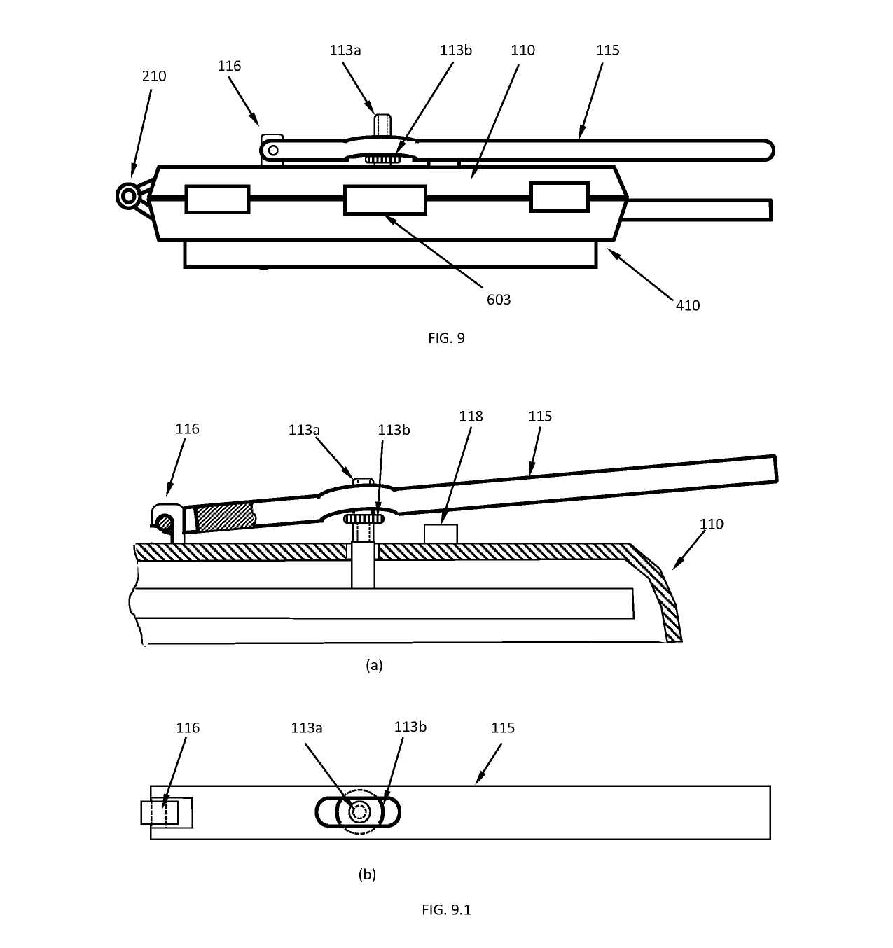

FIG. 8 shows schematically another embodiment of a second type two-side heating fry pan. In this embodiment, the pressing assembly 500 which is basically using a screw for the adjustment of the cooking space, and the means of applying pressure to the food being cooked is replaced by a lever assembly comprising a lever arm 114a, a guiding slot 114b, and a stem 113 which is connected to the top heating plate 112. By applying a force on the lever arm 114a when it is at a pressing position as shown in FIG. 8.1 (b), the stem 113 of the top heating plate, thus the top heating plate 112, will be pressed down. There is a guiding slot 114b that allows the lever arm 114a to slide to different positions. Also, there are a number of dented grooves lined up on a skewed surface on the lever arm 114a. These dented grooves determine the positions of the pressing contact points on the lever arm 114a. Therefore, they are referred to as positioning grooves. With these positioning grooves, the lever arm 114a can press the stem 113 of the top heating plate 112 with different dented groove which will eventually determine the cooking space when the lever arm 114a is fully pressed down as shown in FIG. 8.1 (b). FIG. 8.2 and FIG. 8.3 depict the lever arm 114a and the guiding slot 114b separately. The lever arm 114a in this embodiment also serves as the handle of the fry pan when it is turned over onto the handle position as shown in FIG. 8.1 (a). FIG. 9 shows schematically another embodiment of the two-side heating fry pan with a lever arm 115 on the top part 110. In this embodiment, the cooking space is adjusted by an adjusting nut 113b on the top heating plate stem 113a. A hook up joint 116 connects the lever arm 115 and the top part 110. The hook up joint allows the lever arm 115 to be detached after the use, as shown in FIG. 9.1.

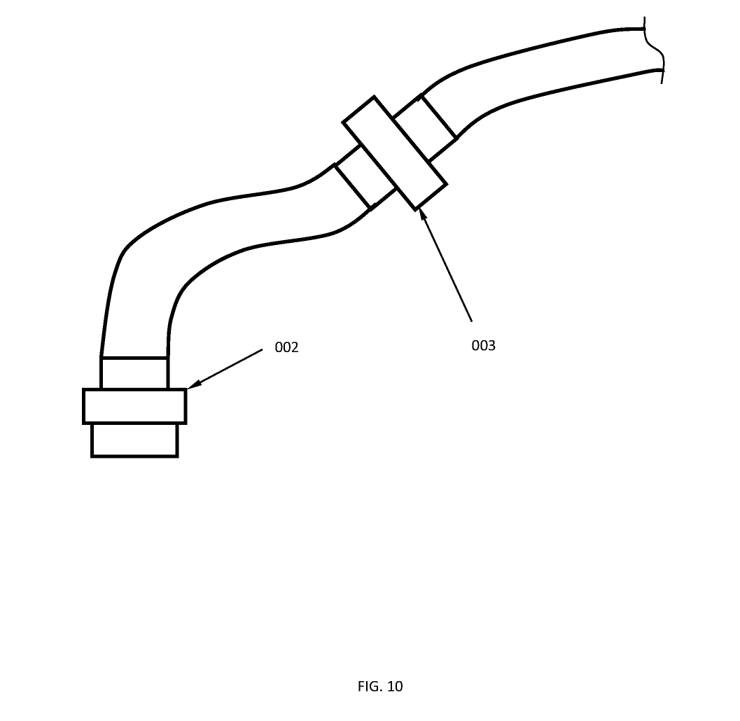

FIG. 10 shows schematically a ventilating pipe which is connected to the ventilating exit 118 on the top part of the fry pan. This ventilating pipe consists of a filter 002 and a ventilating fan 003. There are also a number of pin-holes distributed on the top part 110 of the second type two-side heating fry pan. Since the two-side heating fry pan has an enclosed cooking chamber, the ventilating pipe that directly sucks the air out of the cooking chamber can effectively remove the oily vapor generated during the cooking. The pin-holes distributed on the top part of the fry pan will inlet the air to maintain the pressure inside the cooking chamber natural while the ventilating fan is working. For the first type two-side heating fry pan, pin-holes are not necessary because the gap between the sidewalls of the top part 100 and the bottom part 400 can inlet the air to maintain the pressure inside the cooking chamber natural.

By using a few additional fasten screws 117, the top part of the two-side heating fry pan can be attached to an ordinary fry pan that has a suitable size as shown in FIG. 11.

As used herein, a part or function recited in the singular and proceeded with the word “a” or “an” should be understood as not excluding plural said parts or functions, unless such exclusion is explicitly recited. Furthermore, references to “one embodiment” or “another embodiment” of the claimed invention should not be interpreted as excluding the existence of additional embodiments that also incorporate the recited features.

This written description uses examples to disclose the invention and also to enable any person skilled in the art to practice the invention, including making and using any assembly or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural parts with insubstantial differences from the literal language of the claims.

What is claimed is:

1. A two-side heating fry pan comprising:
a bottom part comprising a bottom wall and a sidewall connected with the bottom wall;
a bottom heating element integrated in the bottom wall of the bottom part;
a top part comprising a top wall and a sidewall connected to the top wall;
a top heating element integrated in the top wall of the top part;
attaching means for removably and adjustably attaching the top part to the bottom part to form a cooking chamber at a desirable distance between the top wall and bottom wall, whereby the top heating element is over the cooking chamber and the bottom heating element on the bottom of the cooking chamber;
a bottom handle being connected to the bottom part at a position that is substantially opposite to the position of the attaching means;
a top handle being connected to the top part at a position that is substantially opposite to the position of the attaching means;
ventilating means for ventilating the cooking chamber and maintaining neutral air pressure in the cooking chamber; and
pressing means for applying clamping force on the top part and the bottom part to compress the food in the cooking chamber.

2. The two-side heating fry pan of the claim 1, wherein the attaching means comprises a T-shaped screw connected to one of the top and the bottom parts and a hook connected to the other of the top and bottom parts so that the screw can be turned up or down to change its position relative to the hook position, thereby affecting the distance between the top wall and the bottom wall of the cooking chamber.

3. The two-side heating fry pan of the claim 1, wherein the attaching means comprises a ladder-like hinge frame connected to one of the top and the bottom parts and a hook connected to the other of the top and the bottom parts so that the hook can be hooked to any of a plurality of steps in the ladder-like hinge frame to achieve different distances between the top wall and the bottom wall of the cooking chamber.

4. The two-side heating fry pan of the claim 1, wherein the attaching means comprises a fixed toothed member connected to one of the top or the bottom parts, a movable toothed member rotatably connected to the other of the top and bottom parts, and a tightening assembly connected to the movable toothed member for achieving different distances between the top wall and the bottom wall of the cooking chamber.

5. The two-side heating fry pan of the claim 1, wherein the pressing means comprises a bolt and cap nut assembly, an external clamp and screw assembly, and a winch and ratchet device, each clamping both the top and bottom handles thus pressing the top heating plate to the bottom heating plate.

6. The two-side heating fry pan of the claim 1 wherein the ventilating means is a ventilation system comprising ventilation pipe, a filter, and a ventilation fan.

7. A two-side heating fry pan comprising:
a bottom part comprising a bottom wall and a sidewall connected to the bottom wall;
a bottom heating element integrated or attached to the bottom wall of the bottom part;
a top part comprising a top wall and a sidewall connected to the top wall;
a top heating plate containing a heating element, the top heating plate being adjustably attached to the top part;
joining means for removably attaching the top part to the bottom part;
a bottom handle being connected to the bottom part at the position that is substantially opposite to the location of the attaching means;
a top handle being connected to the top part at the position that is substantially opposite to the location of the attaching means;
pressing means for applying force on the top heating plate to compress the food in the cooking chamber or control the distance between the top heating plate and the bottom wall of the bottom part;
locking and unlocking means for tightly holding the top part and the bottom part together and allowing the top part to be separated from the bottom part; and
ventilating means for ventilating the cooking chamber and maintaining a neutral air pressure in the cooking chamber.

8. The two-side heating fry pan of the claim 7, wherein the pressing means is selected from the group consisting of a pressing screw assembly, a screw pole, an adjusting nut assembly, and a lever assembly.

9. The two-side heating fry pan of the claim 7, wherein the pressing means comprises a top heating plate stem, a guiding slot attached to the top part, and a level arm with positioning grooves so that the level arm can be engaged with the top heating plate stem to apply force on the top heating plate and control the distance between the top heating plate and the bottom wall of the bottom part.

10. The two-side heating fry pan of the claim 7, wherein the pressing means comprises a top heating plate stem, an adjustable screw for controlling the distance between the top heating plate and the bottom wall of the bottom part, and a level arm on the top of the top part for pressing the top heating plate through the top heating plate stem.

11. The two-side heating fry pan of the claim 7, wherein the locking and unlocking means is either a hook and hook-holder assembly or a sliding square-shaped ring for tightly holding the top part and the bottom part together during the cooking and allowing the top part to be opened.

12. The two-side heating fry pan of the claim 7, wherein the locking and unlocking means is a plurality of rim lockers for tightly holding the top part and the bottom part together during the cooking and allowing the top part to be separated from the bottom part.

13. The two-side heating fry pan of the claim 12, wherein the rim lockers are substituted by a plurality of fastening screw units.

14. The two-side heating fry pan of the claim 7, wherein the joining means is a slide-in hinge or a hook up hinge.

15. The two-side heating fry pan of the claim 7, wherein the ventilating means is a ventilation system comprising ventilation pipe, a filter, a ventilation fan, and a plurality of pin-holes distributed on the top part.

16. A divider for making a plurality of individual multilayer-pancakes.
